(19) United States
(12) Patent Application Publication
(10) Pub. No.: US 2006/0115240 A1
(43) Pub. Date: Jun. 1, 2006

(54) Information recording/reproducing apparatus and method

(76) Inventors: Hideaki Takahashi, Fussa-shi (JP); Tsutomu Mizusawa, Fukaya-shi (JP)

Correspondence Address: DLA PIPER RUDNICK GRAY CARY US LLP, P. O. BOX 9271, RESTON, VA, 20195, US

(21) Appl. No.: 11/261,498

(22) Filed: Oct. 31, 2005

(30) Foreign Application Priority Data
Nov. 30, 2004 (JP) 2004-346561

(51) Int. Cl. H04N 7/26

(52) U.S. Cl. 386/111; 386/124

(57) ABSTRACT

Outputs obtained by dividing a signal into a predetermined number N are respectively decoded and then simultaneously supplied to a plurality of encoders where the outputs are encoded. The outputs encoded in the respective encoders are coupled with each other, thereby reducing the copying speed to 1/N while changing the bit rate of already recorded information.

### CROSS-REFERENCE TO RELATED APPLICATIONS

This application is based upon and claims the benefit of priority from prior Japanese Patent Application No. 2004-346561, filed Nov. 30, 2004, the entire contents of which are incorporated herein by reference.

### BACKGROUND OF THE INVENTION

1. Field of the Invention

The present invention relates to an information recording/reproducing apparatus which can record and reproduce information, and particularly to an information recording/reproducing apparatus and method which can change the bit rate of already recorded information and re-record this information.

2. Description of the Related Art

Information recording/reproducing devices have been widely used which record and reproduce digital information on a recording medium such as an optical disk or a hard disk (which will be referred to as an HDD hereinafter).

In case of, e.g., copying and recording on an optical disk information which has been already recorded on an HDD, a high-speed copying mode has been used which records already recorded information at an N-times speed as compared with the original recording (reproducing) speed. It is to be noted that the high-speed copying mode requires an encoder and a decoder, and hence it is effective only in a copying and recording operation without rate conversion in which information is copied and recorded at the same bit rate as that in recording.

Jpn. Pat. Appln. KOKAI publication No. 2003-224813 proposes a disk picture recording/reproducing apparatus (an information recording/reproducing apparatus) in which a high-speed decoder and encoder used for copying and recording are provided separately from an encoder/decoder usually utilized in picture recording or reproducing. As a result bit rate conversion or high-speed dubbing (copying and recording) from a hard disk (HDD) or an optical disk based on the DVD-R standard is enabled simultaneously with recording or reproducing of a program.

In the disk picture recording/reproducing apparatus described in Jpn. Pat. Appln. KOKAI publication No. 2003-224813, since the high-speed encoder and decoder are provided in addition to the encoder and decoder which are usually used for picture recording or reproducing a program, picture recording or reproducing of a program can be performed simultaneously with conversion of the bit rate or high-speed dubbing from a hard disk to a DVD-R.

However, when converting the bit rate in a copying operation, there is a problem that a time equal to a time required to reproduce an already recorded program (a recording time) is required.

### BRIEF SUMMARY OF THE INVENTION

An aspect of the present invention is directed to an information recording/reproducing apparatus. A first encoder encodes a signal. A second encoder operates independently from the first encoder and encodes a signal different from the signal encoded by the first encoder. A first decoder decodes the signal encoded by the first encoder. A second decoder is configured to operate independently from the first decoder and decodes a signal which is encoded by the second encoder. A recorder is configured to record an encoded signal. A divider divides the encoded signal fetched from the recorder into a predetermined number of signals, so that the divided signals can be provided to the first decoder and the second decoder. A coupler couples the divided signals from the first and second decoders and which are supplied to the first and second encoders to be encoded at a specific bit rate.

### BRIEF DESCRIPTION OF THE SEVERAL VIEWS OF THE DRAWING

The accompanying drawings, which are incorporated in and constitute a part of the specification, illustrate embodiments of the invention.

FIG. 1 is a schematic view showing an information recording/reproducing apparatus as one of embodiments according to the present invention;

FIG. 2 is a flowchart showing an embodiment which realizes a double-speed rate conversion copying in the information recording/reproducing apparatus described in conjunction with FIG. 1;

FIG. 3 is a schematic view illustrating an operation of each constituent element (block) (depicted in FIG. 1) in each stage shown in FIG. 2;

FIG. 4 is a schematic view illustrating a method of dividing a program at the time of double-speed rate conversion copying depicted in FIGS. 2 and 3;

FIG. 5 is a schematic view showing an example of an information recording/reproducing apparatus different from the information recording/reproducing apparatus described in conjunction with FIG. 1;

FIGS. 6A and 6B are schematic views showing an example of an information recording/reproducing apparatus different from the information recording/reproducing apparatus described in conjunction with FIG. 1; and

FIG. 7 is a flowchart showing an embodiment which realizes double-speed rate conversion copying in the information recording/reproducing apparatus described in conjunction with FIGS. 6A and 6B.

### DETAILED DESCRIPTION OF SEVERAL EMBODIMENTS

An embodiment according to the present invention will now be described hereinafter with reference to the accompanying drawings.

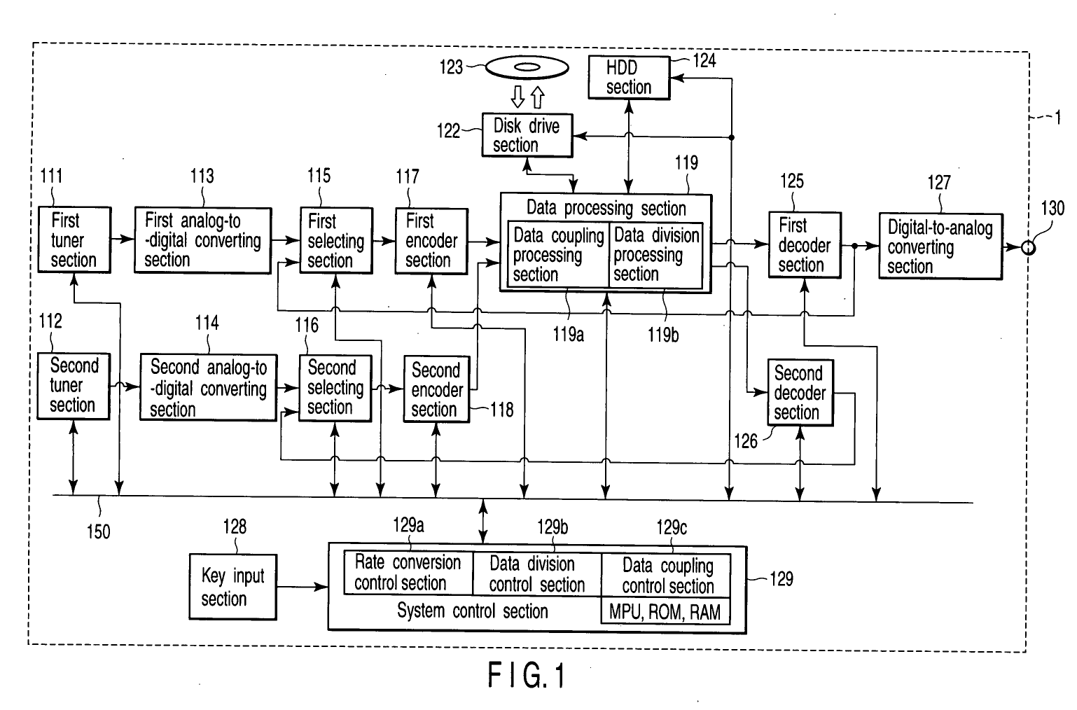

A video recording/reproducing apparatus 1 shown in FIG. 1 has a first tuner section 111, a second tuner section 112, a first analog-to-digital converting section 113, a second analog-to-digital converting section 114, a first selecting section 115, a second selecting section 116, a first encoder section 117, a second encode section 118, a data processing section 119, a disk drive section 122, an HDD (hard disk drive) section 124, a first decoder section 125, a second decoder section 126, a digital-to-analog converting section 127, a key input section 128, a system control section 129, an AV output terminal 130, and a control bus 150. In addition to the first tuner section 111 and the second tuner section 112, an external input terminal to which a video signal or an audio signal can be input from the outside may be provided.

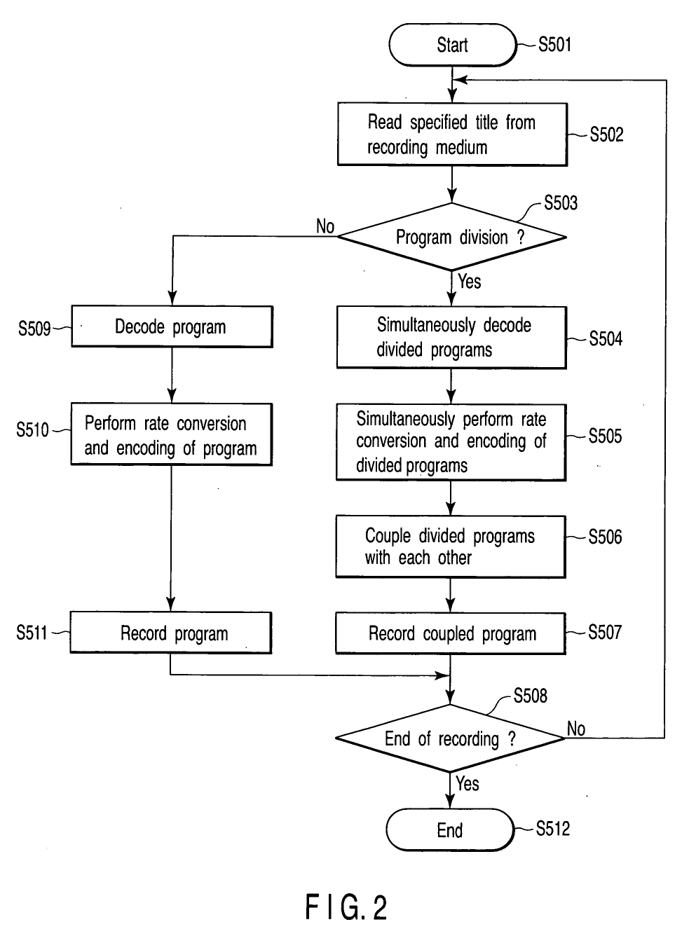

The above-described respective elements (units) are connected with the control bus 150 and controlled by the system control section 129 connected with the control bus 150. A control signal generated by an instruction from a user is supplied to the system control section 129 in accordance with an input operation using the key input section 128. The system control section 129 includes at least a rate conversion control section 129a which controls operations of the data processing section 119, the first and second encoder sections 117 and 118 and the first and second decoder sections 125 and 126 at the time of bit rate conversion copying which will be described below with reference to FIGS. 2 to 4, a data division control section 129b which controls operations of a data coupling processing section 119a and a data division processing section 119b of the data processing section 119, and a data integration control section 129c. It is needless to say that a control signal corresponding to an input operation by a user may be input to the system control section 129 by a non-illustrated non-contact signal input section (a remote control signal receiving section) and a non-illustrated remote control unit which can be substituted for (or which can be used with) the key input section 128.

The system control section 129 includes a micro-processing unit (MPU), a read-only memory (ROM), a random-access memory (RAM) and other conventional components.

An operation of each element (each unit) shown in FIG. 1 will now be described. It is to be noted that a description will be given as to one of two units distinguished as a first unit and a second unit in order to avoid repeated explanation since the two units are substantially the same.

The first tuner section 111 selects a predetermined broadcast channel and receives a broadcast signal from the selected channel.

The broadcast signal selected and received by the first tuner section 111 is converted into a digital signal by the first analog-to-digital converting section 113. That is, an analog video signal and an analog audio signal received by the first tuner section 111 (outputs from the first tuner section 111) are converted into a digital video signal and a digital audio signal by the first analog-to-digital converting section 113. It is to be noted that FIG. 1 shows an example in which a video signal and an audio signal are input to the analog-to-digital converting section without discrimination, but it is needless to say that independent analog-to-digital converting sections may be respectively provided for the video signal and the audio signal.

Digital signals including the video signal and the audio signal output from the first analog-to-digital converting section are input to the subsequent first encoder section 117 through the first selecting section 115. It is to be noted that the first selecting section 115 selects either the digital signal output from the first analog-to-digital converting section 113 or the digital signal including the video signal and the audio signal supplied from the first decoder section 125.

The first encoder section 117 is, e.g., an MPEG encoder. In the first encoder section 117, the video signal is compressed based on, e.g., the MPEG-2 compression encoding scheme. On the other hand, the audio signal is encoded based on, e.g., linear pulse code modulation (LPCM) or an audio digital compression scheme in accordance with a previously selected mode. The respective encoded signals are multiplexed in the first encoder section 117. Therefore, a compressed stream including the video signal and the audio signal is generated in the first encoder section 117.

The compressed stream, i.e., the encoded video signal and audio signal (the encoded data) output from the first encoder section 117 is recorded on an optical disk 123 or a non-illustrated hard disk in a hard disk drive (HDD) 124. The optical disk 123 is a DVD-RAM or the like which is loaded in the disk drive 122 connected with the data processing section 119.

The data processing section 119 includes at least a data division processing section 119b which divides a program recorded in the optical disk 123 or the non-illustrated hard disk in the HDD section 124 into two or more programs during bit rate conversion copying which will be described below with reference to FIGS. 2 to 4, and a data coupling processing section 119a which reassembles the divided programs.

In cases where information recorded in the hard disk or the optical disk 123 is reproduced, the information read through the HDD 124 or the disk drive 122 is supplied to the first decoder portion 125 and decoded (restored). In a regular reproducing operation, the first decoder section 125 is mainly used.

The information (the video signal and the audio signal) decoded in the first decoder 125 is input to the digital-to-analog converting section 127, converted into an analog video signal and an analog audio signal by the digital-to-analog converting section 127, and output to the AV output terminal 130. Therefore, a video and a sound are reproduced by an arbitrary reproducing apparatus connected with the AV output terminal 130, e.g., a television receiver.

The second selecting section 116 inputs either the reception signal from the second tuner 112 or the reproduction signal supplied from the second decoder 126 to the second encoder section 118 like the first selecting section 115 when an operation (recording or reproduction of the second system) is instructed.

For example, in an operation of recording information, when an output from, e.g., the second tuner 112 is selected by the second selecting section 116, a program of a channel different from that of the first tuner 111 is selected and received. The selected and received program is converted into digital signals in the second analog-to-digital converting section 114, and the digital signals can be recorded as a video signal and an audio signal in the optical disk 123 or the hard disk in the HDD section 124 independently from a program of a channel received by the first tuner 111.

On the other hand, when an output from, e.g., the second decoder 126 is selected by the second selecting section 116, a video signal and an audio signal supplied to the second encoder are signals already recorded in the hard disk or the optical disk or the video signal and the audio signal encoded by the first encoder 117 and received by the first tuner 111.

In the information recording/reproducing apparatus 1 shown in FIG. 1, since the two mediums, i.e., the DVD-RAM disk (123) and the hard disk (the HDD section 124) and the data processing section 119 are provided, high-speed copying can be performed from one medium to the other medium through the data processing section 119, for example. Further, information can be recorded in one medium while information in the other medium can be reproduced. It is to be noted that the video signal and the audio signal decoded in the first decoder section 125 can be selected by the first selecting section 115, and hence it is possible to perform rate conversion copying in which a rate of the video signal and the audio signal reproduced from, e.g., one medium can be converted and then these signals are recorded in the other medium. Furthermore, since the video signal and the audio signal decoded in the second decoder section 126 can be selected by the second selecting section 116, rate conversion copying of two programs can be simultaneously executed.

When simultaneously executing the rate conversion copying of two programs, different signals from different programs are selected in the first selecting section 115 and the second selecting section 116, and the two input signals, i.e., the signals from the two programs reproduced from the optical disk 123 or the HDD section 124 and decoded in the first decoder section 125 and second decoder section 126 are again encoded by the first encoder section 117 second encoder section 118. In this case, if the rate conversion is set, the signals are newly encoded at the set rate. The newly encoded video signals and the audio signals after the rate conversion are temporarily recorded in, e.g., the HDD section 124.

Then, the video signals are matched in time information with the audio signals and combined (coupled) in a predetermined order by the data processing section 119. It is to be noted that the video signal and the audio signal processed based on, e.g., the rate conversion copying and newly encoded may be recorded in the optical disk 123 in accordance with a request of a user.

FIG. 2 schematically shows an embodiment which realizes double-speed rate conversion copying in the information recording/reproducing apparatus described in conjunction with FIG. 1.

When the rate conversion copying is started at step S501, a specified program (an already recorded program, i.e., compressed video and audio signals) is read from a recording medium (i.e., the optical disk or the HDD section 124) (S502).

When division of the program is selected (instructed by a user) at step S503 (S503—Yes), the read program is divided into at least two by the data processing section 119, the divided programs are respectively supplied to the first decoder section 125 and the second decoder section 126, and the video signal and the audio signal are simultaneously decoded in the respective sections (S504).

The (divided) programs simultaneously decoded at step S504 are supplied to the corresponding first encoder 117 and the second encoder 118 through the first selecting section 115 and the second selecting section 116. In the respective encoders, the video signal and the audio signal are again encoded at a bit rate corresponding to a request from a user (S505).

The programs divided and again encoded by the respective encoders 117 and 118 at step S505 are coupled with each other in a predetermined order by the control of the data coupling control section of the data processing section 119 (S506), and the coupled program is recorded in a recording area which is previously specified by a user or default setting.

If the double-speed rate conversion copying is not specified (S503—No), the regular rate conversion copying is executed (S509 to S511).

Then, “end of recording?” is checked at a step S508, and the double-speed rate conversion copying is terminated when all of data is processed (S512).

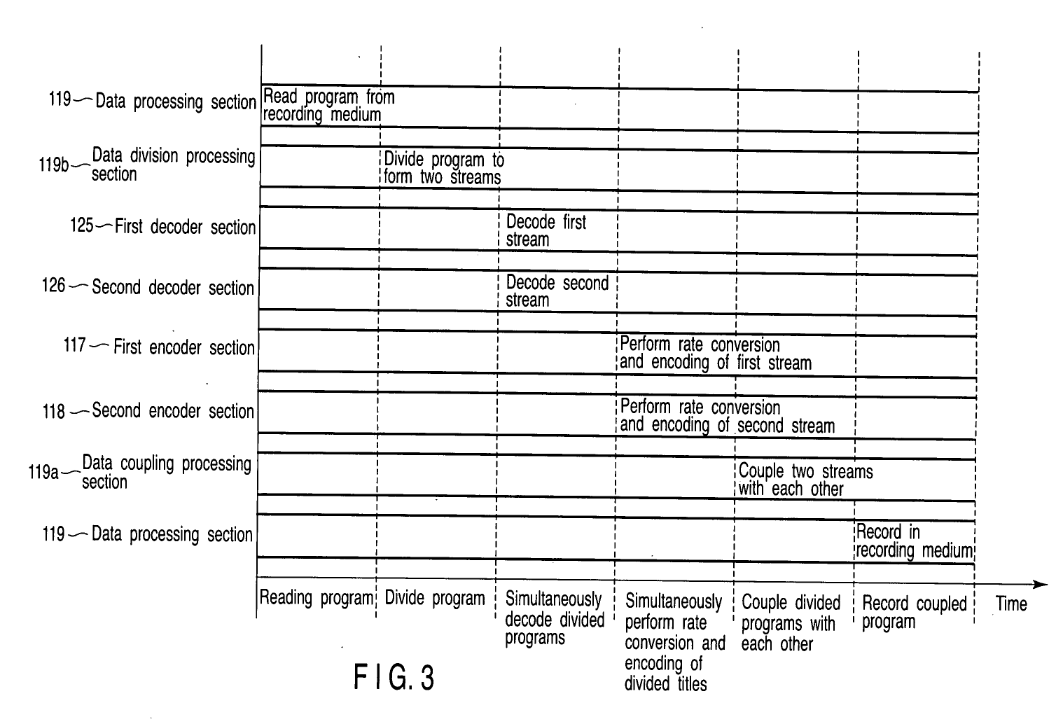

FIG. 3 shows an operation of each constituent element (each block) (depicted in FIG. 1) corresponding to each stage illustrated in FIG. 2.

A program which should be subjected to rate conversion copying and a bit rate of a video signal and an audio signal after conversion are specified from the key input section 128 (or the remote control unit).

Then, the copying speed is set to either “equal speed” or “double speed”.

After appropriate settings, copying is started.

Then, data of the specified program is read from the recording medium (in this example, the HDD section 124) by the data processing section 119 in response to a control signal from the system control section 129 corresponding to the key input (see step S502 in FIG. 2).

If the double-speed rate conversion copying is not specified at step S503, the regular rate conversion copying is carried out without dividing the program into two streams (see steps S509 to S511 in FIG. 2).

If program division is specified at S503, the read program is roughly divided in two (½) to become two streams in the data division processing section 119b in response to a control signal from the data division control section 129b of the system control section 129.

The video signal and the audio signal divided as two streams are respectively supplied to the first decoder section 125 and the second decoder section 126 (see step S503 in FIG. 2).

Then, the two streams are simultaneously decoded in the first decoder section 125 and the second decoder section 126 in response to a control signal from the rate conversion control section 129a of the system control section 129, and the decoded signals are supplied to the first selecting section 115 and the second selecting section 116. It is to be noted that the first selecting section 115 and the second selecting section 116 are switched with a predetermined timing in such a manner that an input from a corresponding decoder section can be selected (see step S504 in FIG. 2).

The video signal and the audio signal from the first decoder section 125 and the second decoder section 126, which are supplied to the first encoder section 117 and the second encoder section 118 through the first selecting section 115 and the second selecting section 116, are subjected to rate conversion to be turned to the video signal and the audio signal each having a specified bit rate by the first encoder section 117 and the second encoder section 118, and again encoded (see step S505 in FIG. 2).

The two streams subjected to rate conversion and encoding by the first encoder section 117 and the second encoder section 118 are supplied to the data processing section 119. The streams input to the data processing section 119 are coupled with each other based on division information (a time or a data quantity [total number of bits]) in the data coupling processing section 119a in accordance with a control signal from the data coupling control section 129c of the system control section 129 (see step S506 in FIG. 2), and recorded in the recording medium (see step S507 in FIG. 2).

Then, reproduction (reading), division, decoding (simultaneous) and encoding (simultaneous) of information are repeated until recording is terminated (see step S508).

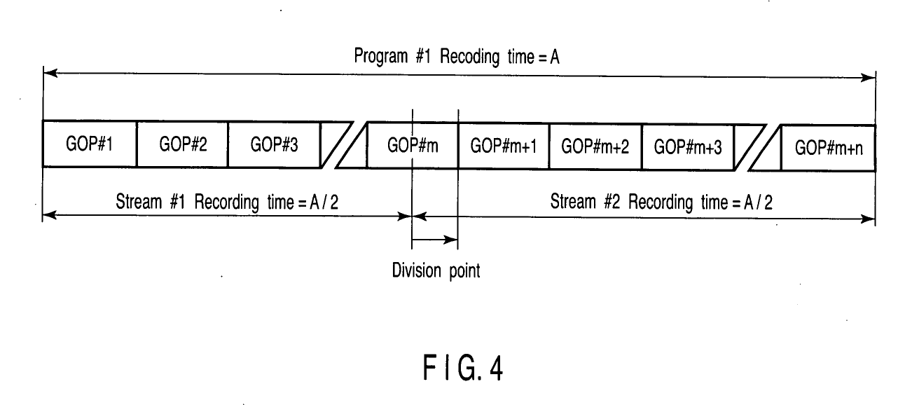

FIG. 4 shows a method of dividing a title at the time of double-speed rate conversion copying depicted in FIGS. 2 and 3.

FIG. 4 illustrates actual video data (a program). Incidentally, it is assumed that actual video data are put together in one file in a recording medium in FIG. 4.

One file comprises one or a plurality of actual video data streams. Each actual video data stream is a unit recorded as a Video Object (VOB) or the like in, e.g., the DVD recoding standards.

One actual video data stream comprises one or a plurality (two) of stream areas, and corresponds to a VOBU (video object unit) in the DVD recording standards or a GOP (group of pictures) in the MPEG2 standards, for example.

It is to be noted that a minimum information unit (size) which enables continuous reproduction while accessing (seeking) data is determined. This unit is a CDA (contiguous data area) and a size of the CDA is a multiple number of an ECC (error correction code) block (16 sectors).

The data processing section 119 receives data in units of a VOBU through a formatter of the first encoder section 117, and supplies data in units of CDA to the disk drive section 122 or the HDD section 124.

An MPU of the system control section 129 creates management information required to reproduce recorded data, and transmits the created management information to the data processing section 119 upon recognizing a data recording end command. Therefore, the MPU of the system control section 129 receives information (division information or the like) in units of data from the first encoder section 117 at the time of encoding information (the video signal and the audio signal). As a result, the management information is recorded in a disk.

Moreover, at the start of recording, the MPU recognizes the management information (a file system) read from the optical disk or the hard disk, and specifies an address and an unrecorded capacity of an unrecorded area in each disk. Therefore, the recording area in which data is recorded is set in a selected disk through the data processing section 119.

Meanwhile, in the bit rate conversion copying in which a bit rate is changed at the time of copying, since a long time is taken (as much as a program reproducing time), it is desirable to divide the data stream in two to cut in half the recording time of the video data (the program) by simultaneously processing in the two encoders. It is needless to say that a division point of the data stream is determined as a GOP (group of picture) which can be a unit in a compression operation and a reproducing/editing operation in the MPEG compression.

In this case, since a middle point of the recording time is not necessarily a boundary of the GOP in the actual video data (the actual program), a boundary of the GOP close to the middle point of the recording time is determined as a division point.

By increasing the number of sets of the encoder section and the decoder section to an arbitrary number N in the information recording/reproducing apparatus 1 shown in FIG. 1, the rate conversion copying can be carried out at an N-times speed. Each additional set of an encoder section and a decoder section can be readily added on, e.g., an expanded board.

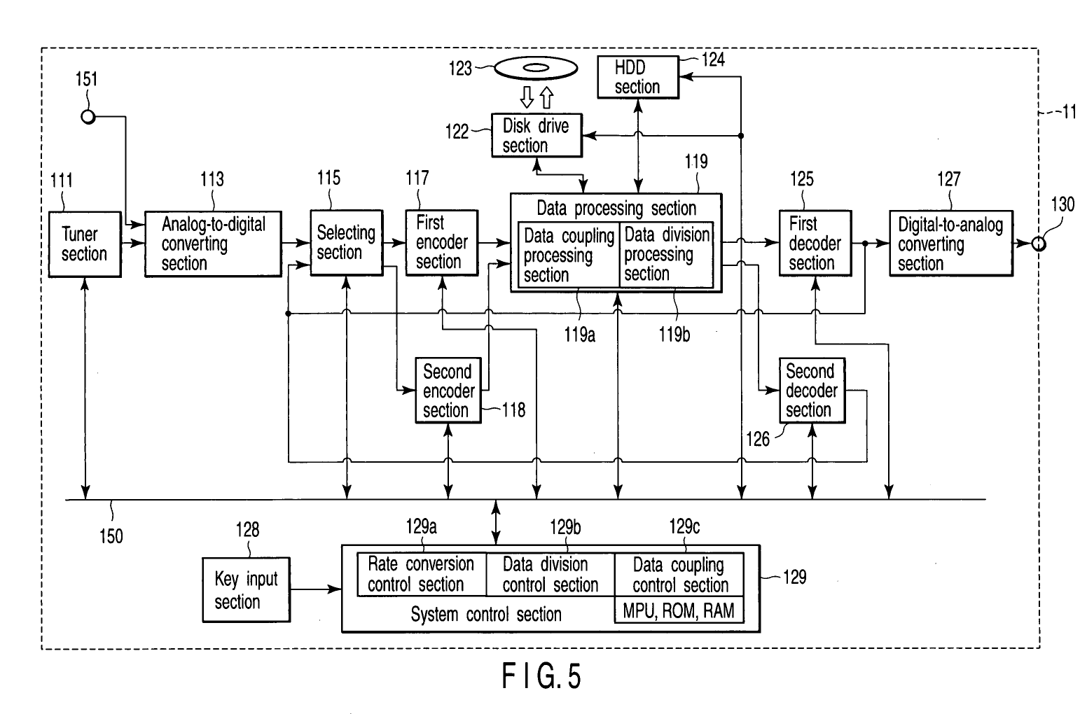

FIG. 5 schematically shows an information recording/reproducing apparatus according to another embodiment of the present invention. It is to be noted that like reference numerals denote the same elements (blocks) as the elements (blocks) depicted in FIG. 1, thereby eliminating the need for a detailed explanation.

In the information recording/reproducing apparatus depicted in FIG. 1, two sets, each including an encoder section, a decoder section and a tuner section, are provided, but the double-speed rate conversion copying described in conjunction with FIGS. 2 and 4 can be accomplished with at least two sets, each including just the encoder section and the decoder section.

By increasing the number of sets of the encoder section and the decoder section to an arbitrary number N in the information recording/reproducing apparatus 11 shown in FIG. 5, the rate conversion copying can be carried out at an N-times speed. Each additional set of an encoder section and a decoder section can be readily added on, e.g., an expanded board.

In this manner, when the two or more sets of an encoder section and a decoder section are provided, the time required for the rate conversion copying is dependent on conditions under which a title can be divided, but it can be reduced to 1/N as a fastest speed.

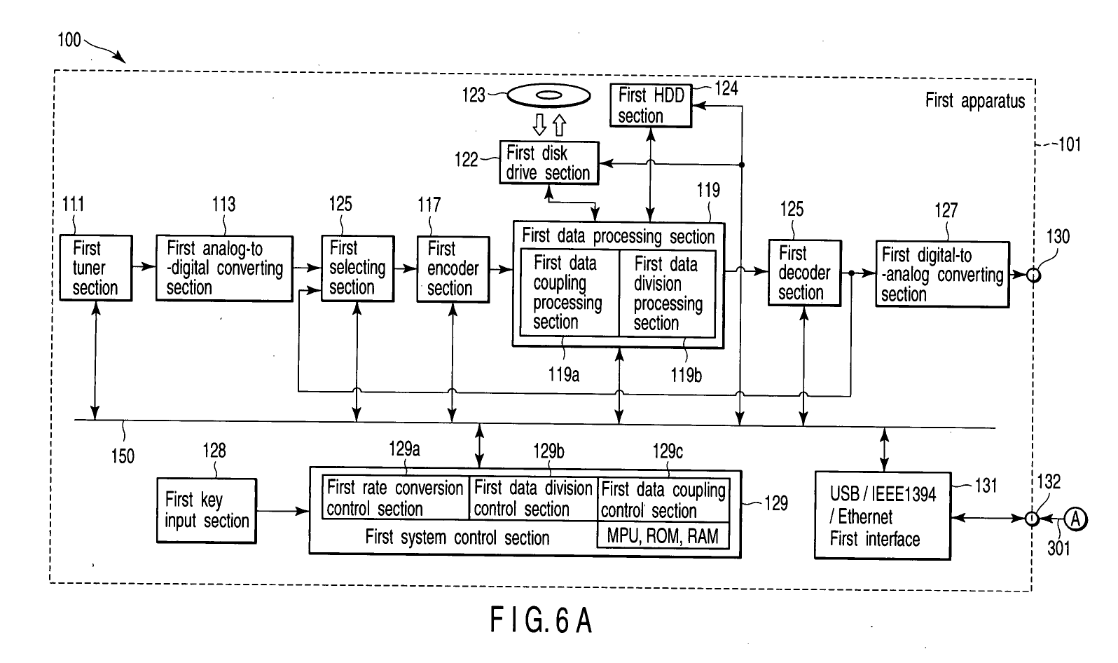

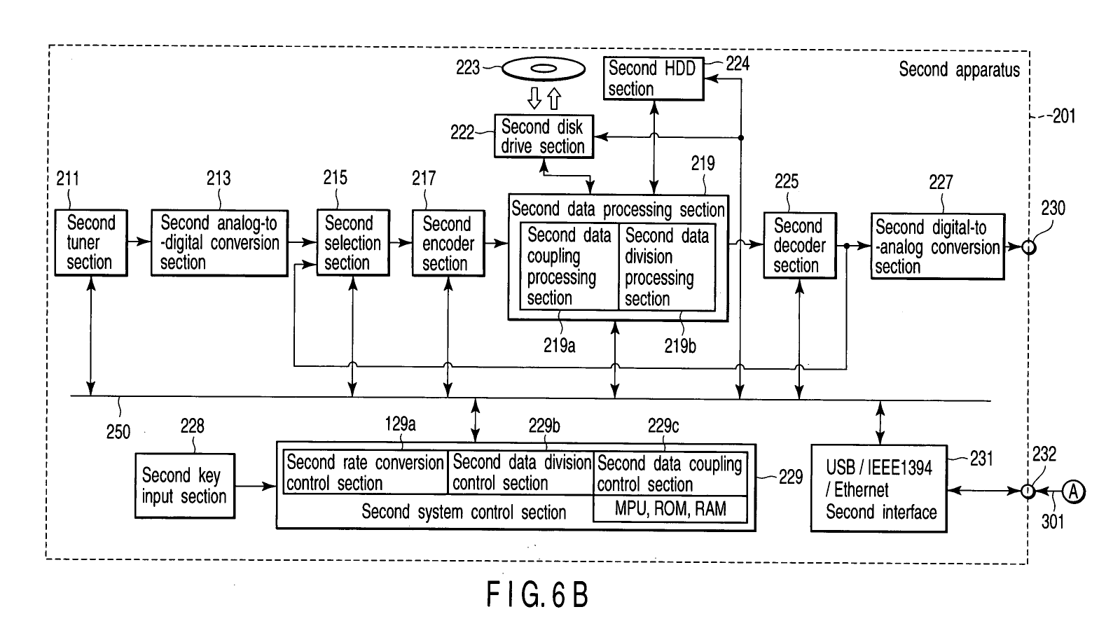

FIGS. 6A and 6B schematically shows an information recording/reproducing apparatus according another embodiment of the present invention. It is to be noted that like reference numerals denote the same elements (blocks) as the elements (blocks) depicted in FIG. 1.

The information recording/reproducing apparatuses 101 and 201 shown in FIGS. 6A and 6B can function like the information recording/reproducing apparatus 1 depicted in FIG. 1 when connected to each other.

In FIGS. 6A and 6B, the first apparatus (the first information recording/reproducing apparatus) 101 of the information recording/reproducing apparatus 100 has a configuration in which the second tuner section 112, the second analog-to-digital converting section 114, the second selecting section 116, the second encoder section 118 and the second decoder section 126 are eliminated from the information recording/reproducing apparatus 1 depicted in FIG. 1, and has an interface 131 which enables transmission/reception of data to/from the other apparatus having the encoder section and the decoder section, and a connection terminal 132. As the interface 131, any known interface such as USB, IEEE1394, Ethernet or the like or a plurality of sets of such interfaces are incorporated.

The second apparatus (the second information recording/reproducing apparatus) 201 will be described by using reference numerals obtained by adding 100 to reference numerals given to the respective elements of the first apparatus for identification, but the second apparatus 201 is substantially the same as the first apparatus 101, and has at least an interface 231 which enables transmission/reception of information with respect to the interface 131 of the first apparatus 101 and a connection terminal 232.

When the interfaces 131 and 231 are connected with each other through a connection cable 301, the first apparatus 101 and the second apparatus 201 mutually share the encoder sections and the decoder sections. Incidentally, it is assumed that control conditions, e.g., which one of the first key input section 128 and the second key input section 228 takes priority or which one of the system control sections 119 and 229 takes priority are previously written in at least firmware of the MPU or the ROM of one of the first apparatus 101 and the second apparatus 201. Moreover, even though the control conditions are written in advance, they can be updated (rewritten) at any time by downloading new control conditions using, e.g., the Internet, a public network, a broadcast satellite or the like.

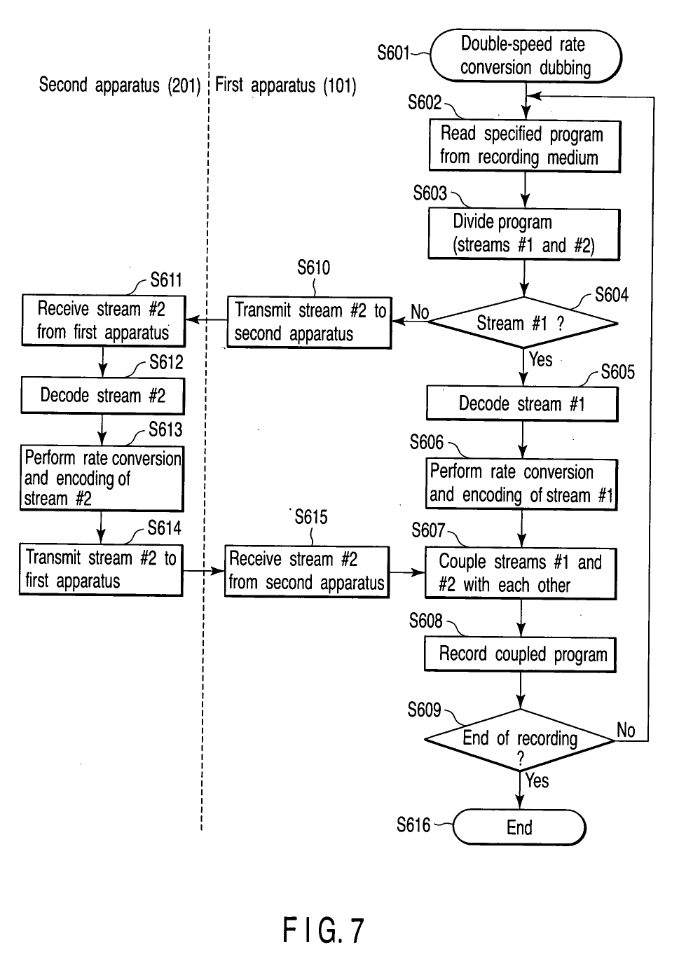

FIG. 7 shows an example of a double-speed rate conversion copying operation procedure in the information recording/reproducing apparatus described in conjunction with FIGS. 6A and 6B. It is to be noted that a description will be given as to an example of an operation performing the rate conversion copying at double speed with respect to a program recorded in a recording medium in the first apparatus 101 by utilizing the encoder in the second apparatus 201 in FIG. 7. Additionally, as to input of the control conditions, it is assumed that input using the first key input section 128 takes priority in principle.

First, a program which should be subjected to the rate conversion copying and a bit rate of a video signal and an audio signal after conversion are specified from the key input section 128 of the first apparatus 101. Then, the copying speed is set to either “equal speed” or “double speed”.

When “start of double-speed rate conversion copying” is instructed at step S601, data of the specified program is read from a recording medium (in this example, the HDD section 124) by the operation of the data processing section 119 based on a control signal from the system control section 129 (S602).

Then, the read program is divided to approximately a half of a recording time to create two streams (the respective divided streams will be referred to as #1 and #2) by the operation of the data division processing section 119b based on a control signal from the data division control section 129b of the system control section 129. For example, stream #1 is supplied to the first decoder section 125 (the first apparatus 101), and the second stream #2 is transferred to the second interface 231 of the second apparatus 201 through the first interface 131 (S604).

Stream #1 decoded by the first decoder section 125 of the first apparatus 101 is supplied to the first encoder 117 through the first selecting section 115 (S605).

The already decoded video signal and audio signal supplied to the first encoder section 117 are subjected to rate conversion to be turned into a video signal and an audio signal having a specified rate, and further encoded (S606).

Simultaneously with this operation, stream #2 supplied from the first apparatus 101 through the interface 231 at step S604 is supplied to the second decoder section 225 through the data processing section 219 of the second apparatus 201 (S611).

Stream #2 decoded by the second decoder section 225 is supplied to the second encoder 215 through the second selecting section 215 (S602).

The already decoded video signal and audio signal supplied to the second encoder are subjected to rate conversion to be turned into a video signal and an audio signal having a specified rate, and further encoded (S613).

Stream #2 subjected to bit rate conversion and encoding at step S613 is transferred to the first apparatus 101 through the interface 231 (S614), and input to the data processing section 119 (S615).

The two streams #1 and #2 of the divided program are coupled as one in the data coupling processing section 119a based on a control signal of the data coupling control section 129c of the system control section 129 (step S607), and the coupled stream is recorded in the recording medium (step S608). Thereafter, reproduction (reading), division, decoding and encoding of information are repeated until recording is terminated (S616).

That is, in the embodiment shown in FIG. 7, the two information recording/reproducing apparatuses each having one set including an encoder section and a decoder section are used. A program recorded in one of the apparatuses is read (S602). The program is divided into stream #1 and stream #2 (S603). Stream #1 and stream #2 are distributed to the different apparatuses (S604). Each stream is temporarily decoded and then again encoded at a specified bit rate by the corresponding encoder section and decoder section in a corresponding information recording/reproducing apparatus (S605 and S606, S612 and S613). Stream #1 and stream #2, subjected to conversion to have a new bit rate and encoding, are coupled with each other in the data processing section of the apparatus in which the program before rate conversion is recorded (S607). Thus one program is copied at a speed specified in accordance with the number of sets of encoder section and decoder section that are provided.

As described above, according to the present invention, one program is divided into two or more streams, each stream is subjected to rate conversion copying, and the streams are finally coupled with each other, thereby enabling rate conversion copying within a time which is usually half the maximum level. If the division number is N, the necessary copying time can be reduced to 1/N.

What is claimed is:

1. An information recording/reproducing apparatus comprising:
a first encoder section which encodes a signal;
a second encoder section which is configured to operate independently from the first encoder section, and encodes a signal different from the signal encoded by the first encoder section;
a first decoder section which decodes the signal encoded by the first encoder section;
a second decoder section which is configured to operate independently from the first decoder section, and decodes the signal encoded by the second encoder section;
a recorder section which records an encoded signal;
a data division processing section which divides into at least two the signal from the recorder section and supplies the divided signals to the first and the second encoder sections; and
a data coupling processing section which couples the divided signals from the first and second decoder sections and which are applied to the first and the second encoder sections to be encoded at a specific bit rate.

2. The information recording/reproducing apparatus according to claim 1, wherein the data division processing section divides the encoded signal to reduce a recording time of the encoded signal to approximately half.

3. The information recording/reproducing apparatus according to claim 2, wherein the data division processing section divides the encoded signal at a specific position so that the divided signals can be again coupled with each other at the division position.

4. The information recording/reproducing apparatus according to claim 2, wherein the encoded signals divided by the data division processing section are simultaneously supplied to the first and the second decoder sections.

5. The information recording/reproducing apparatus according to claim 1, further comprising:
bi-directional communicating means for connecting the first encoder section and the first decoder section with the second encoder section and the second decoder section.

6. The information recording/reproducing apparatus according to claim 5, wherein the data division processing section divides the encoded signal to reduce a recording time of the encoded signal to approximately half.

7. The information recording/reproducing apparatus according to claim 6, wherein the data division processing section divides the encoded signal at a specific position so that the divided signals can be again coupled with each other at the division position.

8. The information recording/reproducing apparatus according to claim 6, wherein the encoded signals divided by the data division processing section are simultaneously supplied to the first and the second decoder section.

9. The information recording/reproducing apparatus according to claim 7, wherein the encoded signals divided by the data division processing section are simultaneously supplied to the first and the second decoder sections.

10. An information recording/reproducing method comprising:
reading an encoded program;
dividing the program into a number corresponding to a number of sets of encoders and decoders;
decoding the divided programs in the respective decoders;
again encoding the respective divided and decoded programs by the corresponding encoders at a specific bit rate; and
coupling outputs from the respective encoders with each other.

11. The information recording/reproducing method according to claim 10, wherein the divided programs are coupled at specific positions, at which the program was originally divided.
